(19) United States
(12) Patent Application Publication
(10) Pub. No.: US 2024/0086934 A1
(43) Pub. Date: Mar. 14, 2024

(54) IDENTIFICATION OF RENEWABLE ENERGY SITE

(71) Applicant: Inventus Holdings, LLC, Juno Beach, FL (US)

(72) Inventors: Aaron P. BLOOM, Mahtomedi, MN (US); Keith J. HARDING, Minneapolis, MN (US); Caitlin A. JOHNSON, Richfield, MN (US); David W. ABEL, Minneapolis, MN (US); Mandeep KAUR, Fremont, CA (US); Timothy D. STOVALL, Kingston, TN (US); Timothy J. KUDALIS, Minneapolis, MN (US); Taran RAJ, Saint Paul, MN (US); Douglas B. SHAFFER, Saint Paul, MN (US); Benjamin D. GRINDY, Minneapolis, MN (US)

(21) Appl. No.: 17/930,764

(22) Filed: Sep. 9, 2022

(51) Int. Cl. G06Q 30/00; G06Q 30/02; G06Q 50/06

(52) U.S. Cl. CPC G06Q 30/018; G06Q 30/0201; G06Q 30/0202; G06Q 50/06

(57) ABSTRACT

Disclosed is a system and method for identifying various combinations of parcels of land with sufficient transmission, resources, market demand, and available land to build a wind farm or solar farm. Different criteria associated with each parcel of land include land characteristics including size, ownership, tree coverage, elevations, terrain, buildable land, transmission characteristics including substation hardware costs, network upgrades, general tie-in costs, market characteristics including historical locational marginal pricing (LMPs), and resource characteristics including net capacity factor (NCF) of wind or solar. In one example, the present invention identifies clusters of land parcels that minimize the number of land owners, maximize buildable land, minimize transmission cost, maximize NCF, and maximize nodal LMPs.

### FIELD OF THE DISCLOSURE

The present invention generally relates to analyzing parcels of land for the development of renewable energy projects, namely wind farms, solar farms, and energy storage, and, more particularly, relates to providing a computer-implemented method and system to automatically position a delineation over a combination of parcels of land for the identification of individual parcels of land, when aggregated, meet the goals for the development of renewable energy projects.

### BACKGROUND

According to the U.S. Department of Energy, more wind energy was installed in the year 2020 than any other energy source, accounting for 42% of new U.S. capacity. In addition, utility-scale solar farm value is projected to quadruple by the year 2027.

Developing utility-scale renewable energy farms take time. There are two distinct phases the development phase and the construction phase. Together they typically take six or more years to complete. The development stage currently takes about two-thirds of this six-year time period. The development stage includes planning and site acquisition, transmission studies and interconnect agreement with the utility, negotiation of the power purchase agreement with a prospective off-taker, transmission permitting, generating permitting and approval, and financing. The construction phase includes the construction of transmission upgrades and site improvement, plant construction, and testing.

To produce renewable energy projects for specific utility-scale generation capacity, typically in Megawatts (MW), parcels of land must review. Identifying the best renewable energy sites across a large geographical area (e.g., the United States) is difficult because many factors, including resource considerations, land considerations, transmission considerations, and market considerations, may render any site uneconomic.

Historically, the development phase planning activities have been manually intensive. In order to determine the final development timeline, a planner models various scenarios in a spreadsheet to ensure operational constraints are respected. At the end of the planning process, there is no way to determine if the final schedule is optimal because of a large number of combinatorial factors are not solvable by a human with a spreadsheet.

### SUMMARY OF THE INVENTION

The present invention provides a novel method and system for identifying various combinations of parcels of land with sufficient transmission, resources, market demand, and available land to build a wind farm, solar farm, or energy storage. Different criteria associated with each parcel of land include land characteristics including size, ownership, tree coverage, elevations, terrain, buildable land, transmission characteristics including substation hardware costs, network upgrades, general tie-in costs, market characteristics including historical locational marginal pricing (LMPs), and resource characteristics including net capacity factor (NCF) of wind or solar. In one example, the present invention identifies clusters of land parcels that minimize the number of land owners, maximize buildable land, minimize transmission cost, maximize NCF, and maximize nodal LMPs.

More specifically, disclosed is a system and method for identifying parcels of land to construct a renewable energy generation facility to generate electricity from wind or solar, or batteries or to construct a data center or other uses. A plurality of projections are performed. The projections begin with receiving an electricity requirement for a new renewable energy generation facility. This electricity requirement is typically expressed in megawatts of power. Next, the process accesses of data elements from a variety of data sources. Each of the data elements is associated with criteria. The criteria is used to project expected electricity output from new renewable energy sources. The criteria include a portfolio of a plurality of parcels of land each with i) land characteristics, ii) electricity transmission characteristics, and iii) market demand characteristics.

The data elements may be converted into a uniform data format within the each of the criteria.

In one example, the criteria of land characteristics for each parcel of land in the portfolio may be any combination of electricity transmission characteristics of the parcel, or market demand characteristics of the parcel. Further, these criteria may include any combination of the size of the parcel, ownership of the parcel, tree coverage in the parcel and/or tree clearing costs, the elevation of the parcel, terrain of the parcel, buildable land area of the parcel, location of the parcel to nearby renewable projects, or a land owner's willingness to sell rights to the parcel. Other criteria for each parcel of land in the portfolio may include the plurality of criteria further includes at least one resource score that is based on the strength of the wind or solar in each of the plurality of parcels of land.

In another example, the criteria of transmission characteristics for each parcel of land in the portfolio may include the size of substation hardware costs, network upgrade costs, or grid tie-in costs.

A total number of simulations (M) are executed in parallel up to the total number of jobs or until a time period expires by evaluating each of the plurality of parcels of land in the portfolio, including the land characteristics, the electricity transmission characteristics, and the market demand associated with the parcels of land in the portfolio. Next, a clustering algorithm is executed to produce results, wherein the results include a subset of the plurality of parcels of land in the portfolio;

The results are ranked from the total number of simulations (M) that meet the electricity requirement combined with a highest combined score of a cumulative size of the subset of the plurality of parcels of land in the portfolio, the electricity transmission characteristics, and the market demand.

The results may be displayed in various formats with various color overlays on maps illustrating the combination of the parcels of land with the highest ranking for development based on the criteria.

### BRIEF DESCRIPTION OF THE DRAWINGS

The accompanying figures, where like reference numerals, refer to identical or functionally similar elements throughout the separate views, and which, together with the detailed description below, are incorporated in and form part of the specification, serve to further illustrate various embodiments and to explain various principles and advantages all in accordance with the present disclosure, in which:

FIG. 1 illustrates a combination of renewable energy sources, specifically wind, solar, and battery, on a parcel of land, according to an example of the present invention;

FIG. 2 illustrates large areas of renewable energy sources using solar across many acres and parcels of land that form a non-rectangular shape, according to an example of the present invention;

FIG. 3 is a pictorial overview of the process of scoring resource characteristics, transmission characteristics, land characteristics, and market demand characteristics for a portfolio of a plurality of land parcels with filtering, clustering, ranking, and presenting, according to an example of the present invention;

FIG. 4 is a pictorial view of 386 different multi-county regions in the continental USA based on ReEDs capacity, according to an example of the present invention;

FIG. 5 is a cluster in Oklahoma (note that the top three owners appear to be the same but are structured differently, according to an example of the present invention;

FIG. 6 is a graph of transmission costs versus transmission scores, according to an example of the present invention;

FIG. 7A is a pictorial map of color-code land score values with various filters for a 150 MW wind farm, and FIG. 7B is as FIG. 7A but for the overall score, according to an example of the present invention;

FIG. 8 is a graph of parcel size score versus land owner's parcel size, according to an example of the present invention:

FIG. 9 is a graph of an owner count score versus the number of owners for solar and wind, according to an example of the present invention:

FIG. 10 is a graph of the buildable area score versus the percentage of buildable land in a search radius, according to an example of the present invention;

FIG. 11 is a graph of the land value score versus parcel value, according to an example of the present invention;

FIG. 12 is a series of pictorial diagrams representing parcel sentiment score, parcel sentiment score boost, land parcel clusters, and cluster sentiment score boost, according to an example of the present invention;

FIG. 13 is a graph of sentiment score adder versus unadjusted score based on the type of land listing, according to an example of the present invention;

FIG. 14A and FIG. 14B are pictorial maps of color-code sentiment boost score values with various filters, according to an example of the present invention:

FIG. 15 is an example user interface that illustrates a pictorial color-coded map of solar prospects recommended by the system with buildable land highlighted, according to an example of the present invention;

FIG. 16 is an example user interface that illustrates a pictorial map of color-code of wind clusters recommended wind cluster of land parcels, including overall score characteristics, plus resource characteristics, land characteristics, transmission characteristics, and other sub-scores, according to an example of the present invention;

FIG. 17 is an example user interface that illustrates a pictorial map of color-code of wind clusters recommended wind cluster of land parcels, including overall score characteristics, plus scores for resource characteristics, land characteristics, and transmission characteristics, as well as land owner sentiment, according to an example of the present invention;

FIG. 18 is a flow method for identifying parcels of land to construct a renewable energy generation facility to generate electricity, according to an example of the present invention; and

FIG. 19 illustrates a block diagram illustrating a processing system for carrying out portions of the present invention.

### DETAILED DESCRIPTION

As required, detailed embodiments are disclosed herein; however, it is to be understood that the disclosed embodiments are merely examples and that the systems and methods described below are embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting but rather to provide an understandable description.

### Non-Limiting Definitions

Generally, the terms “a” or “an”, as used herein, are defined as one or more than one. The term plurality, as used herein, is defined as two or more than two.

The term “adapted to” describes the hardware, software, or a combination of hardware and software that is capable of, able to accommodate, to make, or that is suitable to carry out a given function.

The term “another”, as used herein, is defined as at least a second or more.

The term “configured to” describes the hardware, software, or a combination of hardware and software that is adapted to, set up, arranged, built, composed, constructed, designed, or that has any combination of these characteristics to carry out a given function.

The term “coupled,” as used herein, is defined as “connected,” although not necessarily directly, and not necessarily mechanically.

The term “fatal flaw” or “low score escalators” means that one of the land characteristics for a given parcel of land makes it entirely undesirable for development, even if the other land characteristics score high. For example, if the land owner is listed as a U.S. National Park, this parcel of land, in general, is not feasible for development.

The term “independent system operator” or “ISO” is an organization formed at the recommendation of the Federal Energy Regulatory Commission. In the areas where an ISO is established, it coordinates, controls, and monitors the operation of the electrical power system, usually within a single U.S. state but sometimes encompassing multiple states. Regional Transmission Organizations (RTOs) typically perform the same functions as ISOs but cover a larger geographic area.

The terms “including” and “having,” as used herein, are defined as comprising (i.e., open language).

The term “land characteristics” includes size, ownership, tree coverage, elevations, terrain, buildable land, location of nearby renewable projects, and the owner's willingness or sentiment to sell rights.

The term “locational marginal pricing” or “LMP” is adapting wholesale electric energy prices to reflect the value of electric energy at different locations, accounting for the patterns of load, generation, and the physical limits of the transmission system.

The term “net capacity factor” or “NCF” is the ratio of actual electrical energy output over a given period of time divided by the theoretical continuous maximum electrical energy output over that period.

The term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The term “resource characteristics” includes the net capacity factor (NCF) of wind or solar, which describes the fraction of total capacity that is produced over the course of a typical year. Typical total capacities include 20, 25, 50, 75, 100, 150, 200, 250, and 400 Megawatts. Note solar capacities are typically on the lower end, and wind capacities are typically on the higher end of these typical capacities.

The term “simultaneous” means computations are carried out at the same time, which for larger data sets with various constraints, is not possible to be carried out completed by a group of humans and must be performed by a computer. For example, one human could not compute one simulation with all the constraints for thousands of various clusters of parcels of land across multiple counties and across multiple states with all the various criteria. It is infeasible for a human to calculate one simulation loop with one constraint, let alone perform it in parallel to a sort of global optimum.

The term “transmission characteristics” includes substation hardware costs, network upgrades, and grid tie-in costs, such as those to be compatible with Federal Energy Regulatory Commission Order 845.

The term “uniform data format” means data in a given format, whether date format, time format, currency format, scientific format, text format, or fractional format, so that all values of data are presented in a single consistent format for a given category or criteria.

It should be understood that the steps of the methods set forth herein are not necessarily required to be performed in the order described, and the order of the steps of such methods should be understood to be merely exemplary. Likewise, additional steps may be included in such methods, and certain steps may be omitted or combined in methods consistent with various embodiments of the present device.

Although the elements in the following method claims, if any, are recited in a particular sequence with corresponding labeling unless the claim recitations otherwise imply a particular sequence for implementing some or all of those elements, those elements are not necessarily intended to be limited to being implemented in that particular sequence.

### Overview

Disclosed is a system for identifying a broad range of utility-scale renewable energy sites that are likely to be profitable and successful, across the whole country, based on a ranking algorithm that is displayed within a user interface (UI). The system provides developers with actionable information that increases the likelihood of project success while reducing the time to conclude recommended clusters of land parcels and a streamlined user interface that provides information not readily available.

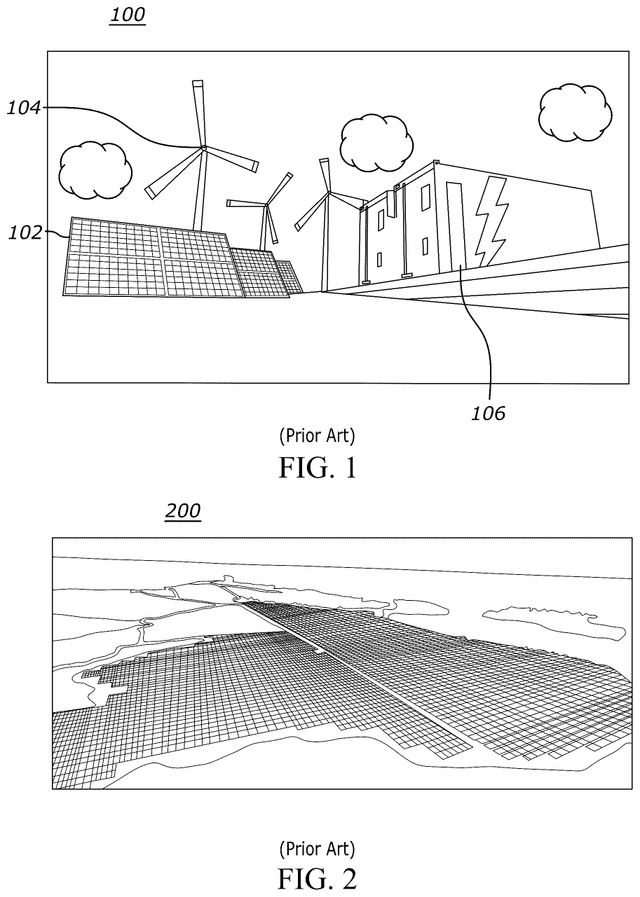

Turning to FIG. 1, shown is a combination of renewable energy sources 100. More specifically, shown is solar arrays 102, wind turbines 104, and battery storage 106. The present invention provides a method and system for identifying suitable combinations of parcels of land to construct these types of facilities.

FIG. 2 illustrates large areas of renewable energy sources 200 using solar across many acres and parcels of land that form a non-rectangular shape, according to an example of the present invention;

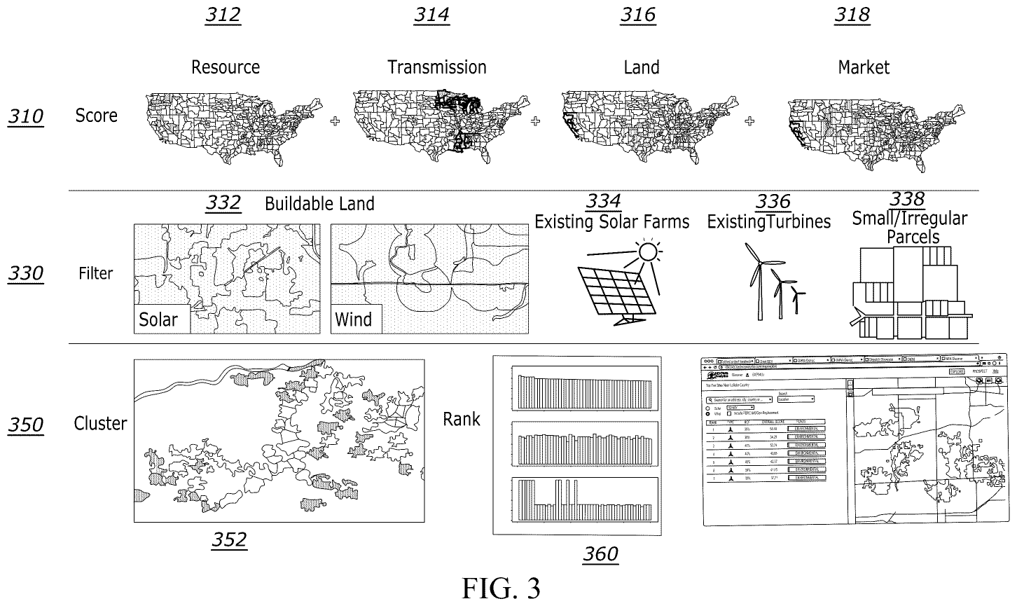

A high-level overview of one example of the present invention is shown in FIG. 3. More specifically, FIG. 3 is a pictorial overview 300 of the process. The process begins by looking at a variety of characteristics for each land parcel in a portfolio of land parcels. Characteristics include resource characteristics 312, transmission characteristics 314, land characteristics 316, and market characteristics 318. Next, filters 330 are applied to each parcel of land. Filters include buildable land 332, distance to nearby or existing solar 334 and wind turbines 336, and irregular and small parcels 338. After filters in 330, clustering 350 of each parcel of land in the portfolio is performed. The results are ranked that meet an electricity requirement combined with a highest combined score of a cumulative size of the subset of the parcels of land in the portfolio, the electricity transmission characteristics, and the market demand. These rankings are shown in user interface 360 as shown with color coding, charts, and other information, including overlays of maps as shown.

In one example, the system includes a prospecting tool that ranks every land parcel in the country based on the high-level characteristics that influence project viability. The goal is to improve the odds of a prospect getting built and to reach a quicker conclusion.

The system combines all of the high-level factors that go into evaluating a successful prospect. Optional features may include: i) land parcel ownership, ii) evaluations extend nationwide in land parcel review, and iii) displaying relevant data layers that identify nearby features of significance.

The total score combines sub-scores, representing how feasible different components are, and can be adjusted for different types of prospects. For example, this prospecting tool is used for data centers and battery energy storage site selections, and additional types of prospects beyond renewable energy, data centers, and batteries for a cluster of land are planned.

Scores are combined. The combined score means that a very low score in one category allows the tool to avoid “fatal flaws” or “low score escalators” with projects. That is, the identification of a potential “fatal flaw” is such that it ranks a group of land parcels much lower, eliminating them from consideration. For example, the fatal flaws may include very high transmission costs, very long gen-tie lines, and too many landowners in an area.

For each cluster of land parcels, the system provides an overall score, which is a weighted value based on individual scores for resource, land, transmission, and market characteristics. Users can initiate a utility-scale wind or solar prospect within the user interface based on recommended clusters of land parcels, drawing their own candidate, or uploading external geospatial files.

The system quantifies the tradeoffs between resource, transmission, market, and land constraints that influence whether wind and/or solar project is successful. The ranking system identifies the best clusters of land parcels sufficient to build a utility-scale wind and solar farm and identifies those with the best combination of resource, transmission, and market characteristics while maximizing buildable land and minimizing land owners. In one example, the system evaluates enough clusters of land parcels to build 29 Terawatts of solar capacity spread across 1.1 million virtual solar farms and 5 Terawatts of wind capacity across 100,000 virtual wind farms across the contiguous United States. The virtual or potential wind and solar farms being ranked could provide 25 times the U.S. total electricity capacity, giving developers a cache of actionable intelligence that can improve the wind and solar development process to significantly reduce carbon emissions of America's electric power generation critical infrastructure.

Utility-Scale Wind/Solar Algorithm

The overall goal of land parcel clustering is to recommend clusters of parcels that have sufficient transmission, resources, market demand, and available land to build a wind or solar farm. Considers land characteristics (Land Score), transmission characteristics (substation hardware costs, network upgrades, gen-tie cost), market characteristics (historical LMPs), and resources (wind/solar NCF) in producing clusters of land parcels that minimize the number of land owners, maximize buildable land, minimize transmission cost, maximize NCF, and maximize nodal LMPs.

Standalone Storage Algorithm

In one example, the present invention brings together the factors, such as, the proximity to the substation, battery arbitrage opportunities, and land parcel characteristics (buildable land and building footprints) that influence the viability of standalone storage prospects, ultimately recommending the best properties to pursue these projects. The ultimate goal is to provide battery prospectors with recommendations of land parcels that have sufficient open land near substations that have good arbitrage opportunities. The system is also designed to generally highlight land and transmission characteristics more than market/arbitrage characteristics (until additional and more comprehensive arbitrage/load data), so users can pan on the user interface map based on displayed arbitrage values and then zoom into the appropriate scale for prospecting.

Data Center Algorithm

In one example, the present invention brings together the factors, including the proximity to fiber/population center/substation, land parcel characteristics, and more that influence the viability of data center prospects, ultimately recommending the best properties to pursue for these projects. Parcels within a small radius (typically 50 miles) of the center of major metro areas (top 100) are filtered and scored based on their proximity to fiber and transmission substations and land characteristics (number of buildings in parcel, the concentration of buildable land for a data center, the concentration of buildable land for a 25 MW solar plant).

Technical Document

The overall goal of the land parcel clustering algorithm is to codify all of the major influences on wind and solar prospect viability for every land parcel in the country, based on interviews with developers, historical analyses, and financial/physical relationships. The present invention produces an algorithm recommending clusters of parcels with sufficient transmission, resources, market demand, available land, and positive land owner sentiment to build a wind or solar farm. Developers see the clusters of parcels in a given area that have the best chance of culminating in a constructed wind/solar farm without showing any areas with insufficient land for construction. In designing the clustering algorithm, the main goals are to 1) provide reasonable compact clusters of parcels with minimal land ownership and 2) score those clusters with the appropriate tradeoffs between transmission, resource, market demand, suitable/advantageous land, and land owner sentiment. Here, details about the clustering and considerations as development continues are considered.

Overall, the system filters and ranks all land parcels throughout the country based on a combination of transmission/land/market/resource scores and then clusters them together to form enough buildable land to build wind or solar farms of five different capacities. All clusters of land parcels are then scored based on their transmission/land/market/resource scores. Developers in the Discover User Interface (discover.nexteraanalytics.com) can then view the top ten clusters of land parcels for wind or solar farms of a given capacity within the geographic area displayed in the user interface.

Documentation of Algorithm

The land parcel clustering, the process starts with reasonable objective assumptions that inform the weighting of score components and filtering of parcels. The process then continues by modifying the weighting of score components (resource/transmission/market/land as well as the components of the land score) to force the most appropriately shaped and ranked clusters.

Development of Clustering Algorithm
Do the top ten options represent an appropriate mix of good transmission, good land, and good resource? Are they consistently dominated by one component?
Does the weighting/filtering penalize clusters that have very low scores in transmission, resource, or land?
   Great transmission but low available land/high land parcel density: retiring plant surrounded by acreages
   Great land surrounded by full substations
   Great land but a very poor resource
   Great resource but poor availability of land. For example, the following types of clusters may appear, such as many different land owners or sparse buildable land.
   Most appropriate weights that replicate variations in tax-efficient Levelized Cost of Energy (LCOE) and Levelized Cost of Transmission (LCOT)
   Modify weights based on examination of tradeoffs in cluster rankings

Process

In one example, the process begins with identifying the technology type, such as solar farm, wind farm, energy storage, or data center, and the capacity desired.

Load nationwide data.
The code starts by loading nationwide gridded “ranker data” (nationwide grids of resource, transmission, and market characteristics/scores) that are produced by solar farm locations, wind turbine locations, and data intelligence and marketplace for land, such as the nationwide LandGate listings available at online URL <www.landgate.com>. Data gathered is arranged on a lxi km grid for solar over the continental USA and on a 2×2 km grid for wind.

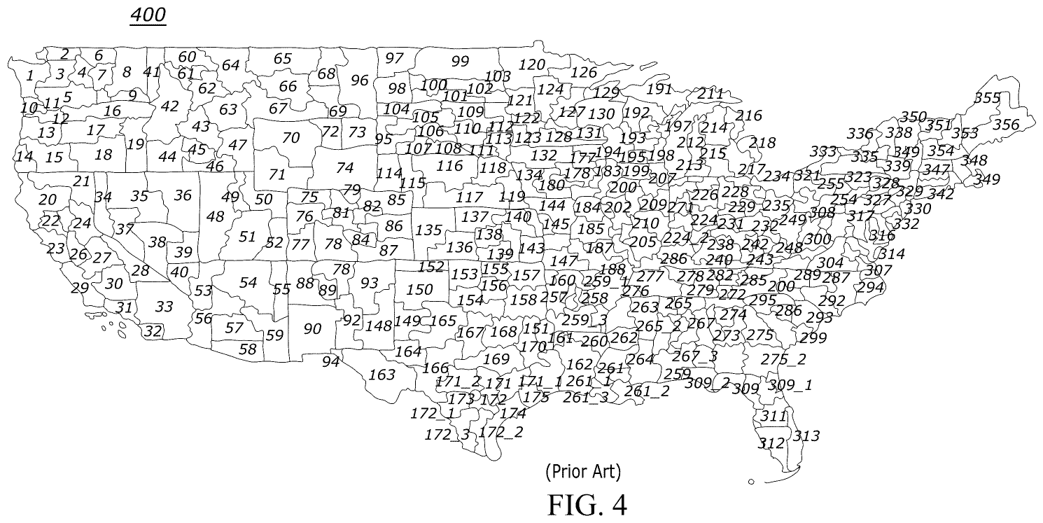

Turning to FIG. 4 is a pictorial view 400 of the 386 different multi-county regions in the continental USA derived from resource supply regions from NREL's Renewable Energy Deployment System (ReEDs), according to an example of the present invention.

Loop Over Different Multi-County Regions Across the Continental USA (CONUS).
In one example, the system runs nationwide. However, it loops over 386 different multi-county regions in the country, which are based on the resource supply regions of the ReEDs capacity expansion model (there were 356 regions, but several were broken into smaller sizes to reduce memory and denoted with suffixes like “1”, “2”, or “3”).

Load Regional Data, Subset Region Data, and Merged Together
While in a particular clustering region, all of the filtered land parcel data, buildable land data, and tree cover data (if applicable) are loaded and merged together with the gridded “ranker data” and LandGate listings (defined above). In this manner, statistics about every single filtered land parcel in the region is processed, including parcel metadata, transmission costs/scores, market scores, NCFs, resource scores, total tree coverage (if applicable), buildable land area, LandGate listing information, etc.

Score Land Parcels
All land parcels in a region are then scored and prepped for clustering, which will be done for all filtered land parcels in a region.

Build all Possible Clusters Centered on Every Single Filtered Land Parcel
After loading and merging all the data, the system tries to build clusters starting at all land parcels of sufficient size (>5 acres) in the function for a given plant capacity, where it searches for all land parcels within a small radius (that scales by the farm capacity). It then ranks and sorts the parcel scores grouped by the land owner and land parcel scores within a search radius (scaled to the capacity of the farm). Next, the highest score parcels are selected from each owner until a sufficient buildable acreage is collected to support the construction of a plant of a given capacity. If not enough buildable land exists to build a plant of a given capacity, no clusters are built, and the system moves on to the next starting land parcel. The system also uses a distance score that adjusts all land parcels within the small search radius based on the distance from the centroid land parcel (starting parcel) and the distribution of scores in the search radius. This allows clusters to be generally more compact when they are initially built but has no impact on which clusters are eventually chosen when all possible clusters are ranked.
Distance score (temporary score introduced to give more weight to land parcels closer to the “starting land parcel.”
   To encourage the choice of parcels closer to the center of each cluster, a score is assigned to each parcel based on the distance from the starting parcel. This score is used only when sorting parcels and not in the final land score or total score.
   The “distance_score_subtractor” is simply the standard deviation (scores within the search radius for each cluster) multiplied by the distance from the starting parcel centroid/search radius. It is only applied when sorting by owner in the parcel clustering.
   To get the mean owner count score (defined further below) for the parcel clustering, the mean of all parcels by owner is calculated plus the minimum “distance_score_subtractor” for parcels associated with that owner. That way, the best parcels from owners that are generally close to the starting parcel are prioritized.
   The distance score is meant to prioritize land owners (and their parcels) closer to the center of the search radius, which produces more contiguous clusters in areas with many landowners. Because the system gathers parcels together by groups of land owners, the distance score generally has a negligible impact on the number of land owners but instead has a large impact on which land owners are chosen in areas with many owners of small parcels (it will choose owners closer to the center of the search radius).

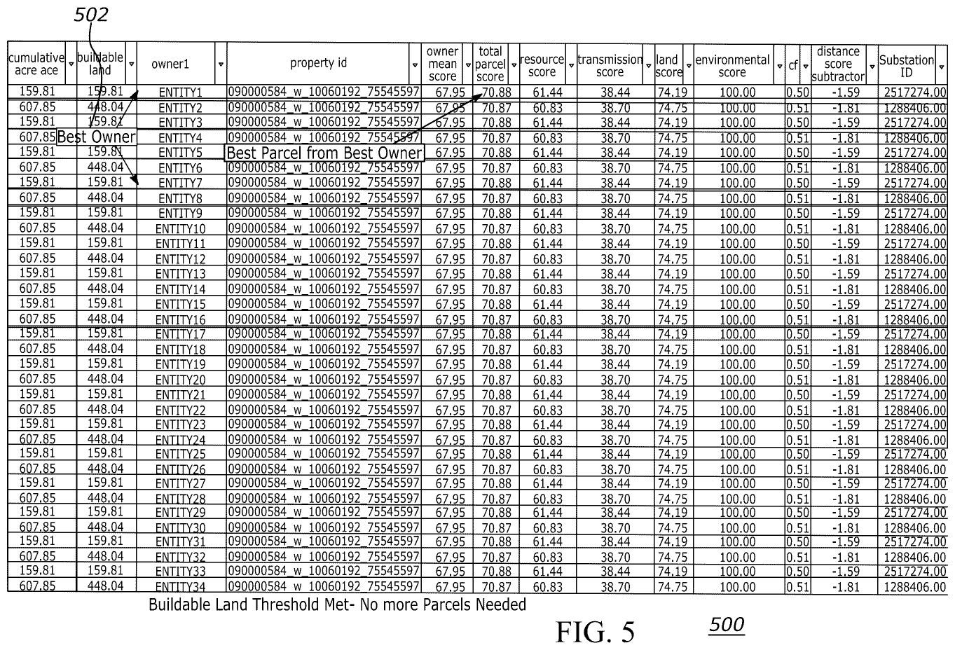

FIG. 5 is a table view of a cluster in Oklahoma 500, according to an example of the present invention. Note that the top three owners 502 appear to be the same but are structured differently.

Rank all Possible Land Parcel Clusters
After building clusters around all filtered parcels with enough buildable land in the search radius, it sorts the clusters by score and removes any overlapping clusters with lower scores. The system iteratively chooses the best non-overlapping clusters until none are left or the specified number of clusters has been chosen. It also adds some ranking information to the output and formats/filters the output, and saves it to a file for a national aggregation later.

National Aggregation and Normalization
After all the regions have been run, the file outputs from each region are loaded sequentially, and then scores are normalized to a final 0-100 score.
All national files are outputted to S3, and the data is ingested into the Discover UI.

Filtering

Filtering allows objective removal of non-buildable areas and tries to consider edge cases where appropriate without being too restrictive. Areas that provide marginal or atypical development potential are kept in the system but are generally scored lower.

Wind Filters
Wind Buildable Land:
   One example makes use of a geospatial database. The geospatial database is a collection of land areas that can technically support the construction and permitting of wind turbines based on sufficient setbacks from existing building footprints, transportation corridors, transmission lines, pipelines, airports, protected lands, critical habitats, wetlands, operating wind farms, city limits, and areas prone to frequent flooding.
Existing wind farms (from USGS/AWEA database) with 10 km buffer
   Sources include: <https://eerscmap.usgs.gov/uswtdb>
Elevations >3000 meters
Parcels with very long/very scattered shapes: meant to remove transportation corridors and limited cases where all parcels with missing data in a county are grouped together
Parcels with small amounts of buildable land (scaled to farm size due to computing limitations)
   50 MW: <2 acres of buildable land
   100 MW: <4 acres of buildable land
   150 MW: <6 acres of buildable land
   200 MW: <8 acres of buildable land
   300 MW: <12 acres of buildable land
Very large parcels with <10% buildable land (meant to remove very large parcels that typically don't have much contiguous buildable land)

Solar Filters
Solar Buildable Land:
   One example makes use of a geospatial database. The geospatial database is a collection of land areas that can technically support the construction and permitting of solar farms based on sufficient setbacks from existing building footprints, transportation corridors, transmission lines, pipelines, airports, helicopter landing pads, protected lands, critical habitat, wetlands, steep slopes, city limits, and areas prone to frequent flooding.
Parcels with small amounts of buildable land (scaled to farm size due to computing limitations)
   25 MW: <0.25 acres of buildable land
   50 MW: <0.5 acres of buildable land
   75 MW: <0.75 acres of buildable land
   150 MW: <1.5 acres of buildable land
   250 MW: <2.5 acres of buildable land
Elevations >3000 meters
Parcels with very long/very scattered shapes: meant to remove transportation corridors and limited cases where all parcels with missing data in a county are grouped together and existing solar farms (from EIA)
Very large parcels with <10% buildable land (meant to remove very large parcels that typically don't have much contiguous buildable land)

Assumptions

Wind
Wind Farm Land Density (land_density): 60 acres/MW
Capacity: 50, 100, 150, 200, 300 MW
Buildable_frac_in_radius (0.2) is the fraction of buildable land required in the search radius for building a cluster. If not enough options are showing up in an area, then the search radius can be increased by reducing Buildable_frac_in_radius.
Search radius (in km): (([1/buildable_frac_in_radius]*land_density*Capacity)/(247*pi)), where 247 is the number of acres per square kilometer. It is the radius of a circle that makes an area large enough to produce five (1/buildable_frac_in_radius) times the buildable land needed (a wind farm can be built if 20% of the land in that radius is buildable)

Solar
Solar Farm Land Density (land_density): 12 acres/MW, approximately 150% of the final density for solar farms (according to meet market requirements for Northeastern/Southeastern U.S.) to allow for secondary land options when signing up land owners, and to give more spatial variety of cluster options
Capacity: 25, 50, 75, 150, 250 MW
Buildable_frac_in_radius (0.25) is the fraction of buildable land required in the search radius for building a cluster. If not enough options are showing up in an area, then the search radius can be increased by reducing Buildable_frac_in_radius.
Search radius (in km): (([1/buildable_frac_in_radius]*land density*Capacity)/(247*pi)), where 247 is the number of acres per square kilometer.

Score Components and Weights

Resource Score
The Resource Score (100=best, 0=worst) describes the relative strength of the wind/solar resource over a given cluster of land parcels. It is calculated by converting NCF estimates for each lxi km solar grid cell and each 2×2 km wind grid cell into a 0-100 score. To do this, the distributions of wind and solar NCFs are extended from the 5th percentile to the maximum to get 0-100 scores for wind and for solar independently. Resource scores are calculated for each land parcel based on weighted area averages of grid cells within a parcel, which helps determine which parcels are chosen by the clustering algorithm. Resource scores are also calculated for each cluster based on the weighted area average of resource scores from each land parcel.
An area-weighted average of resource score in the cluster
Weight for overall score: (wind=0.375, solar=0.2)

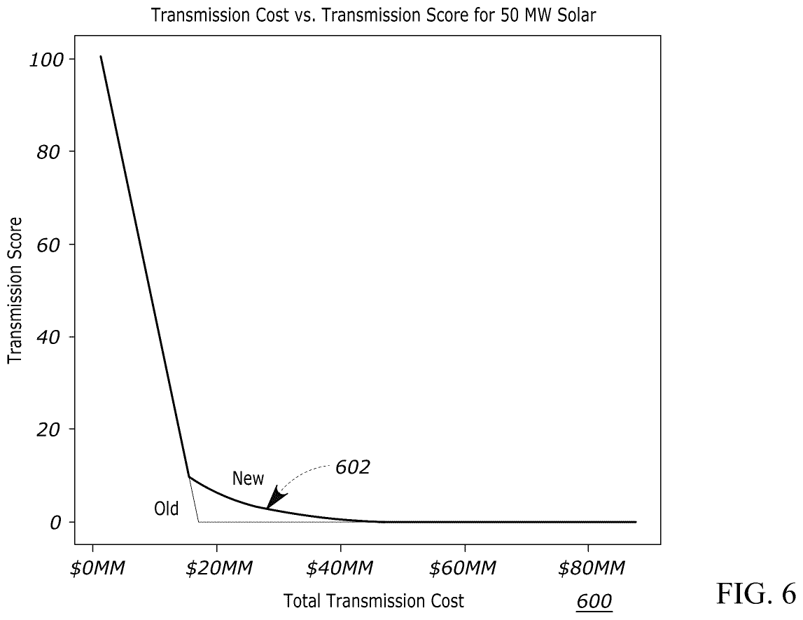

Transmission Score
FIG. 6 is a graph of transmission costs versus transmission scores 600, according to an example of the present invention.
The Transmission Score (100=best, 0=worst) describes how characteristics of the transmission network (congestion, queue positions, substation/tap costs, gen-tie line length) can ease project advancement or present barriers to development. It is calculated by converting the sum of the network upgrade costs, interconnection facility cost, and cost to a 0-100 score for the cheapest bus out of the 100 closest intrastate busses or the cheapest line tap. Gen-tie line is an industry term that means the generation-intertie overhead electric line that will connect the wind/solar project substation to the utility substation owned by the transmission owner. Note that region 602 illustrates the exponential score decay enables gen-tie length to influence score at a very high cost.
The transmission score of a cluster is based on the highest transmission score from any of the closest gridded points (transmission scores are calculated for wind and solar grids) within the cluster, whether that connection is to an existing substation or for a new line tap.
Example weight for overall score: (wind=0.25, solar=0.35)

Market Score
The Market Score (100=best, 0=worst) quantifies the market conditions for developing wind or solar in a given location. This is determined by calculating the 40th percentile of generation-weighted LMPs (for wind and for solar) using hourly energy time series and hourly historical LMPs from analytical software for the energy industry, such as Velocity Suite available from Hitachi Energy, using the median and standard deviation of generation-weighted LMPs and assuming a gaussian distribution. The system then converts them to a 0-100 score by converting the distribution of generation-weighted LMPs to 0-100 (modifying them so that the highest generated-weighted LMPs are 100) within each ISO. In one example, the system uses the 40th percentile to effectively penalize nodes with substantial variability/risk (which is not advantageous unless doing arbitrage) while still choosing a value close to the median.
The market score of the highest-scoring bus (based on the weighted average of transmission score and market score for all gids in the cluster) for any grid point within the cluster
Weight for overall score (wind=0.125, solar=0.10)

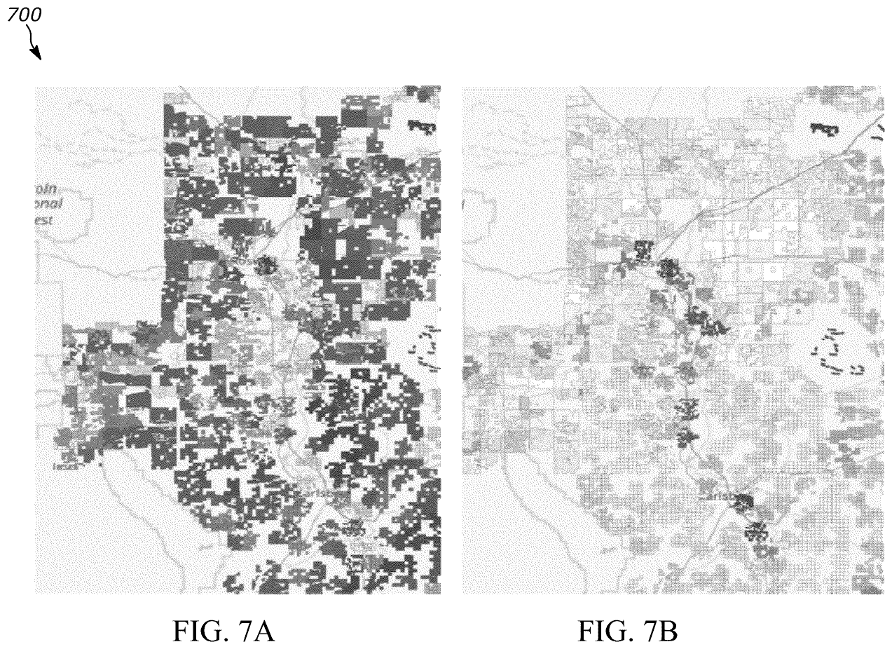

Land Score
The Land Score (100=best, 0=worst) describes the land characteristics that influence the feasibility of completing a project. It is the weighted sum of the Parcel Size Score, Owner Count Score, Buildable Land Score, Land Cost Score, and Environmental Score. The Buildable Land Score is a 0-100 score that scores the amount of buildable land in the vicinity (0=least land, 100=most land). The Land Cost score estimates the relative cost of tree clearing costs on a land parcel. The Environmental Score uses a count of relevant environmental layers from the Nature Conservancy, converted to a 0-100 score (0=most layers, 100=no layers), for each parcel and averaged over the cluster.
Sum of land score components (see below), which are a mix of weighted area averages of parcels and cluster summary statistics.
Turning to FIG. 7A and FIG. 7B are pictorial maps 700 of color-code land score values with various filters, according to an example of the present invention. Shown are land scores overlaid on a map as shown (green=100, red=15).
Weight for overall score (wind=0.25, solar=0.35).

Land Score Components

In one example, different land scores are added that form appropriate cluster shapes and give a proper ranking of clusters. The system uses scoring to pick the best parcels within a cluster and rank the clusters based on land/transmission/resource/market.

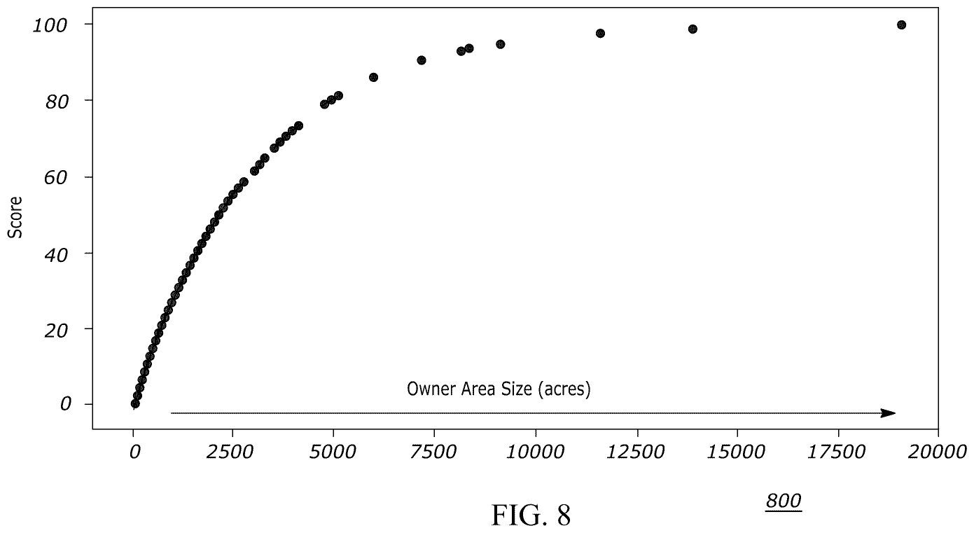

Turning to FIG. 8 is a graph of Parcel Size Score versus land owner's parcel size 800, according to an example of the present invention.

Parcel Size Score: Wind Weight=0.42, Solar Weight=0.25 (for calculation of Land Score)
The Parcel Size Score is designed to nudge the recommendations towards larger land parcels, and larger swaths of single-owner occupied land. It is assigned based on the total buildable acreage by owner in the search radius of a starting parcel (0=tiny parcels, 100=giant single owner swaths of land).
Each parcel gets assigned a Parcel Size Score based on the size of common parcels from each owner in the search radius, which influences which parcels get chosen by the clustering algorithm and favors the choice of big swaths of parcels from the same owner within the clustering algorithm.
The score assigned to each parcel is based on the total owner area within the search radius. The equation uses a variable “parcel_size_cost_coefficient” which varies between wind/solar and modifies the steepness of the curve. For solar, the owner area size curve is steeper to prioritize differences at smaller parcel sizes.
Each cluster's Parcel Size Score is the weighted area average of parcel size score, which favors clusters with large swaths of land.

Owner Count Score: Wind Weight=0.37, Solar Weight=0.35 (for calculation of Land Score)
The Owner Count Score is meant to nudge the recommendations towards clusters of land parcels that have fewer land owners, preferably one. It is an exponentially decaying score with each additional land owner in a cluster, starting at a score of 100 for one owner and approaching zero for ten land owners for solar and 50 land owners for wind. The equation uses a variable “owner_score_coefficient” which varies between wind/solar and modifies the steepness of the curve, with a steeper curve for solar than wind that is designed to give more priority to minimizing the number of land owners for solar than for wind.

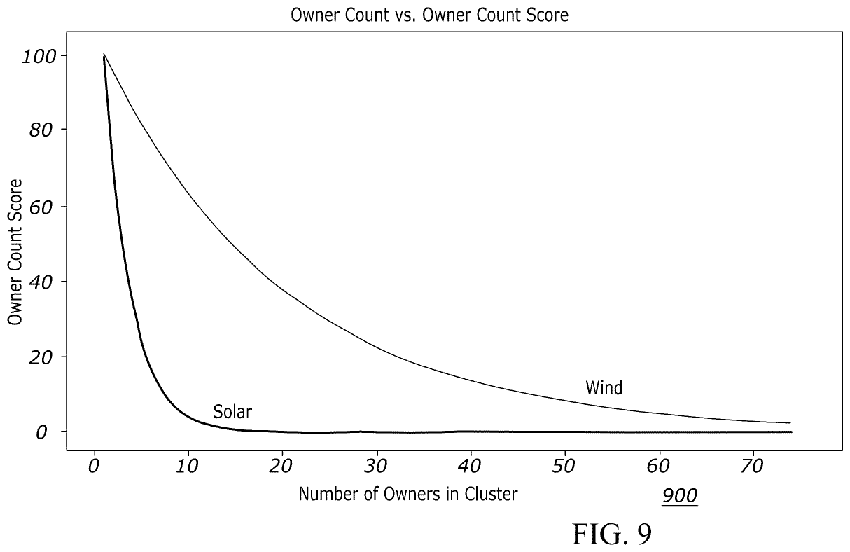

FIG. 9 is a graph of Owner Count Score versus the number of owners 900, according to an example of the present invention. For solar, the owner score drops much faster to emphasize the greater need to minimize the number of land owners for solar compared to wind.

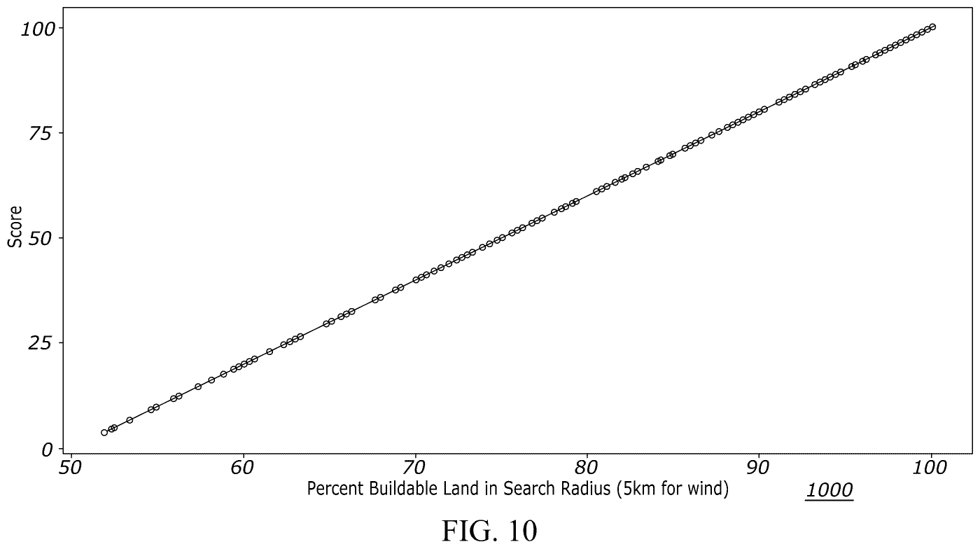

Buildable Land Score: Wind Weight=0.21, Solar Weight=0.20 (for calculation of Land Score)
The Buildable Land Score is meant to nudge the recommendations towards clusters of land parcels that are in areas with fewer potential land constraints. A 0-100 score scores the amount of buildable land in the vicinity (0=least land, 100=most land), with a declining score for each percent of available buildable land. A typical range may be from 20% to 100% buildable.
FIG. 10 is a graph of the score of a parcel of Buildable Land Score versus the percentage of buildable land in a search radius of 1000, according to an example of the present invention. In this example, 5 kilometers are used for wind, which is the approximate search radius for a 50 MW wind farm. As shown, the system favors clusters with large amounts of buildable land available in ranking.

Land cost score: Weight=0.2 for solar, 0 for wind
The Land Cost Score is designed to shift the recommendations from the system away from areas that may have prohibitive construction costs. It is based on the percent of the buildable land that is not covered in trees, according to the US Forest Service Tree Canopy Cover Database.
   In one example, land cost score=100−2*percent tree coverage in buildable land of the parcel (e.g., 25% tree coverage on buildable land=land cost score of 50)
The Land Cost Score has increased weight as the Land Cost score decreases below a certain threshold (50%, which corresponds to 25% tree coverage), canceling out any benefit from large land parcels or a small number of land owners in a cluster. The goal here is to give a benefit to parcels/clusters with low tree coverage (high land cost score) while also having a prohibitive cost penalty once the tree cover exceeds a defined value so that large heavily tree-covered clusters (typically National/State Forest lands or timber company properties) are not favored by the system even if they have other favorable land characteristics such as a single owner.

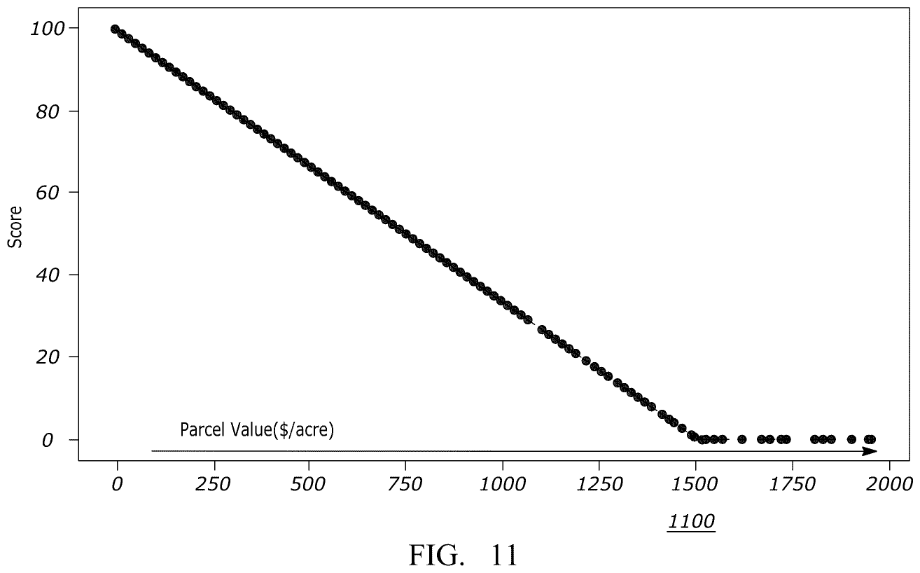

Land value score: Weight=0 to 0.05
FIG. 11 is a graph of the score of a parcel of land versus parcel value 1100, according to an example of the present invention. Much of the land value data may be incomplete and does not warrant inclusion in the land scoring algorithm. It will increase to 0.05 when land rental rates are accessed for each parcel based on USDA county-level rental rates and satellite info about cropland/non-cropland.

Low Score Escalators
Very poor land characteristics, very high transmission costs, or very low wind resources can have a very large negative impact on the viability of a recommended cluster, yet their scores can be relatively high if other score components are high. In order to increase the influence of these very low scores on the total score (and which particular clusters are recommended in the user interface), any land/transmission/resource score that is very low (<10) has a linearly increasing weight that also decreases the weight of other categories (to a minimum of 0.05). In this manner, a cluster with a transmission score of 0 will have a total score of 15 if other scores are 100 (without this weighting, such a wind prospect would have a score of 75 (assuming a transmission weight of 25%).

Sentiment Score Boost

The addition of third-party (LandGate in this case) advertisements from land owners about their desire to lease their land for wind, solar, or other mineral rights can help address another potential hurdle to renewable development: land owner sentiment. Combining this with Discover's core system gives users further insights into the main drivers of prospect viability.

LandGate is a website where landowners advertise their land for mineral/renewables leases, providing a powerful avenue to identify willing landowners. The system uses sentiment scoring, to prove a conditional score boost to land parcels (and clusters) that have land owners advertising their land for renewable (or other) leases on third-party websites like LandGate via a Sentiment Score Boost. The system also gives a partial Sentiment Score Boost to any additional land parcels nearby that the system identifies are owned by a land owner that advertised their land for renewable energy leases.

The Sentiment Score Boost is applied to each parcel (100 if the listing is in the same technology being considered in the algorithm, 75 if it is another renewable technology, 50 if it is oil/gas/mining or other properties owned by a “lister”), apply a Sentiment Score Boost based on the total score of the parcel 1200, cluster parcels together based on parcel scores and methods described previously, recalculate total scores, and then apply a sentiment boost to the cluster based on a weighted area average of the sentiment scores for parcels in the clusters.

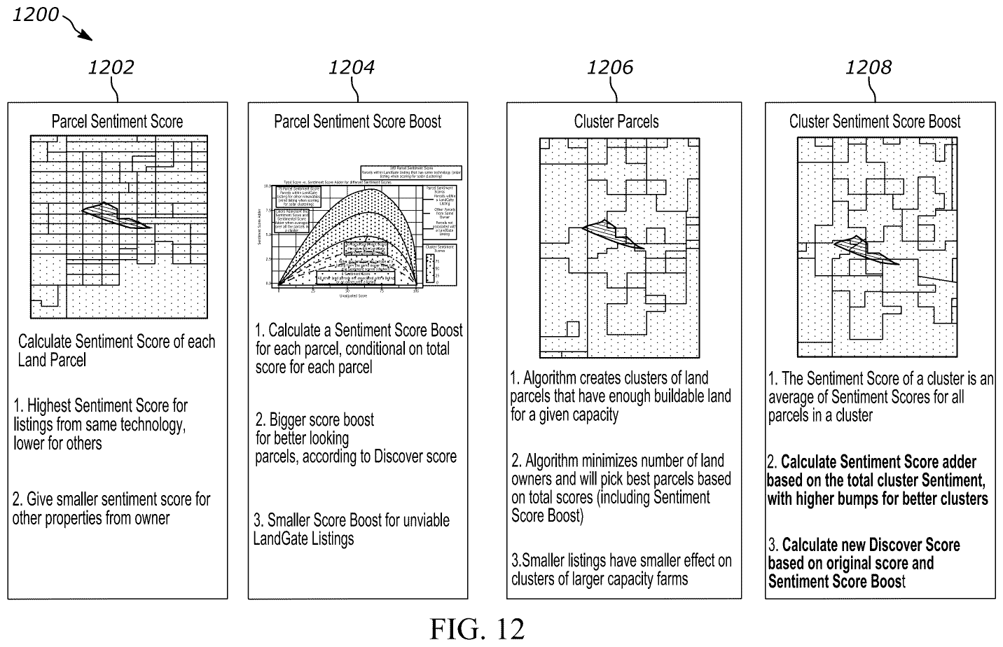

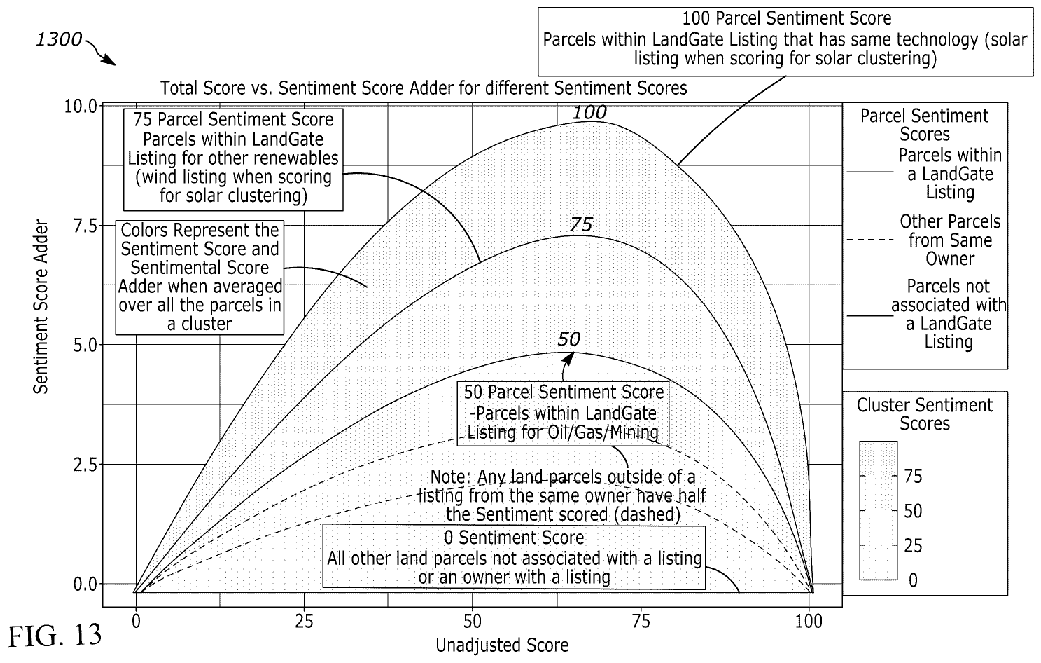

FIG. 12 is a series of pictorial diagrams 1200 representing parcel sentiment score 1202, parcel sentiment score boost 1204, parcel clustering 1206, and cluster sentiment score boost 1208. FIG. 13 is a graph of sentiment score adder versus unadjusted score 1300.

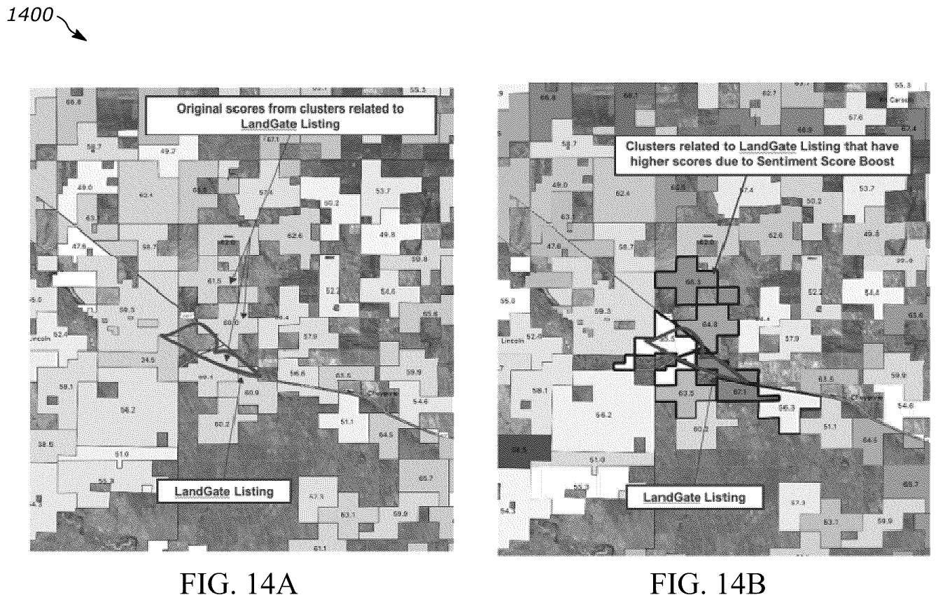

FIG. 14A and FIG. 14B are pictorial maps 1400 of color-code sentiment boost score values with various filters, according to an example of the present invention.

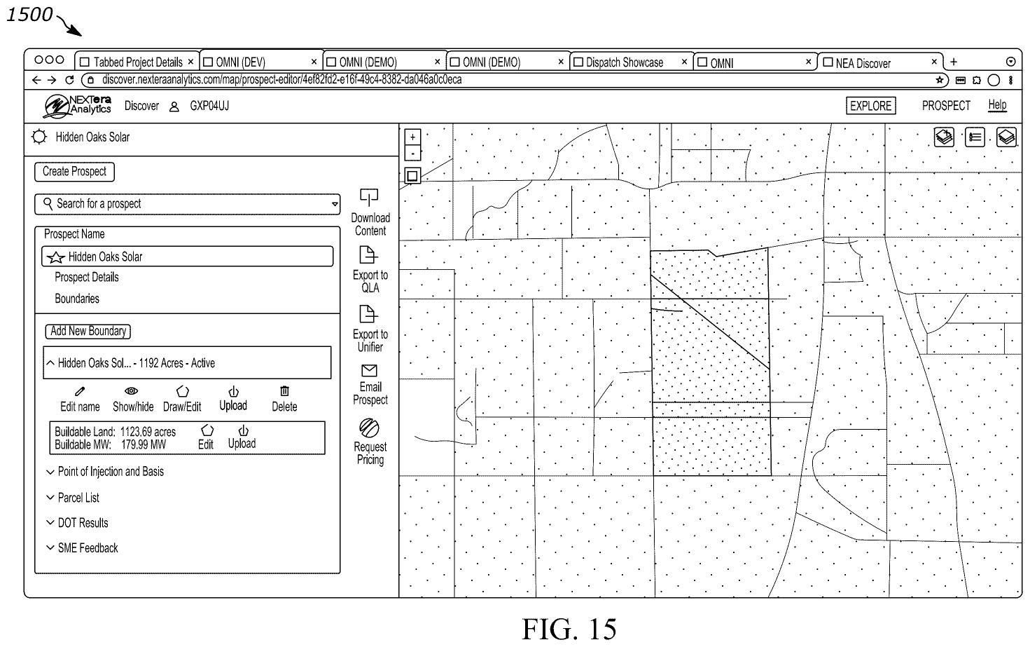

FIG. 15 is an example of a user interface 1500 that illustrates a pictorial map of color-coded solar prospects recommended by the system with buildable land highlighted, according to an example of the present invention.

Discover Score
Scores are normalized to a 0-100 scale by linearly stretching the distribution of weighted average scores.

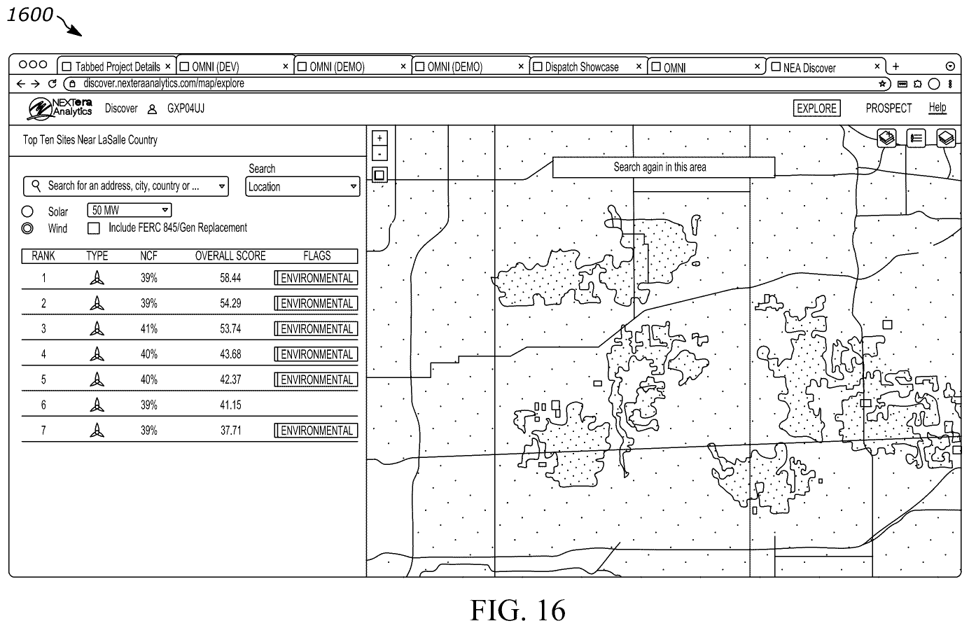

FIG. 16 is an example user interface that illustrates a pictorial map 1600 of color-code of wind clusters recommended wind cluster of land parcels, including overall score characteristics, plus resource characteristics, land characteristics, transmission characteristics, and other sub-scores, according to an example of the present invention. Land Parcels with a high sentiment score and a high score receive a larger sentiment score boost.

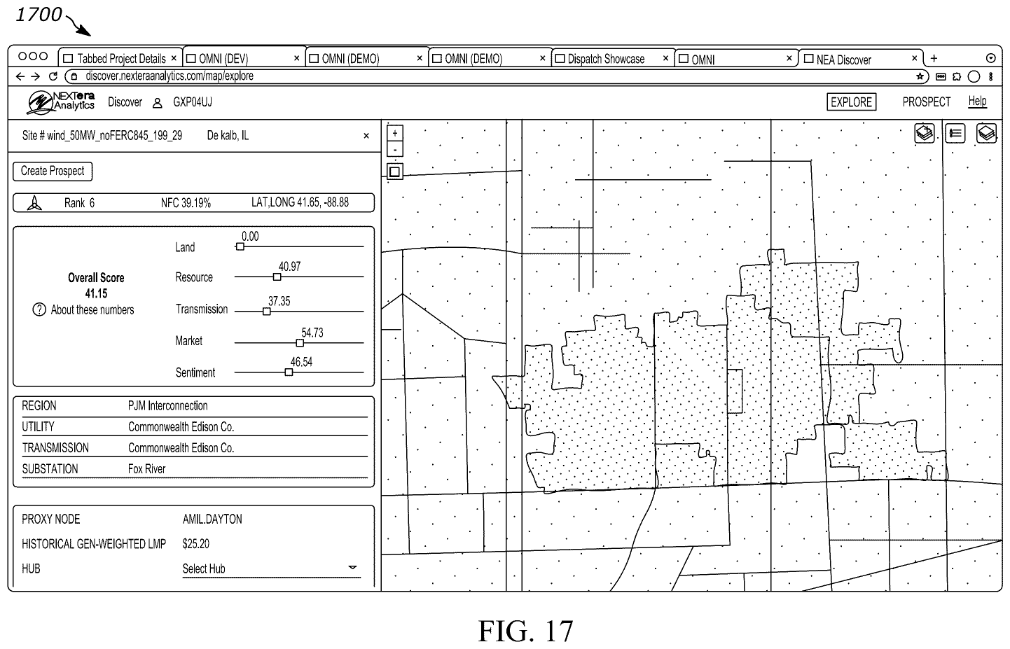

FIG. 17 is an example user interface that illustrates a pictorial map 1700 of color-code of wind clusters recommended wind cluster of land parcels, including overall score characteristics, plus resource characteristics, land characteristics, transmission characteristics, and other sub-scores, according to an example of the present invention. As documented elsewhere on this page, the system creates clusters of land parcels that have enough buildable land for a given capacity.

Flow

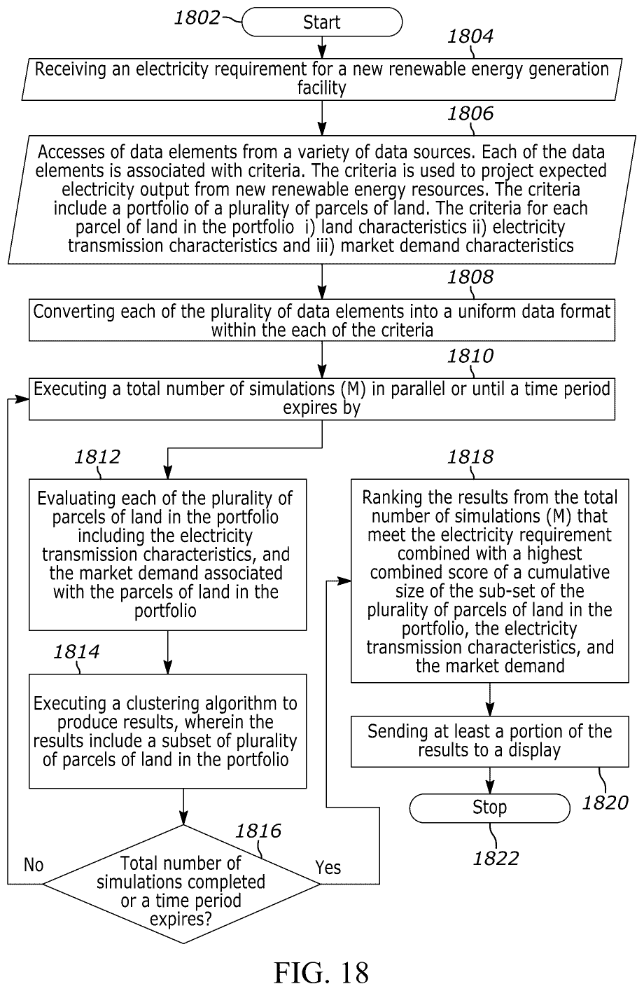

Turning now to FIG. 18, shown is a flow method 1800 for identifying parcels of land to construct a renewable energy generation facility to generate electricity, according to an example of the present invention. The process begins in step 1802 and immediately proceeds to step 1804, where a plurality of projections is performed. The projections begin with receiving an electricity requirement for a new renewable energy generation facility. This electricity requirement is typically expressed in megawatts of power. The process continues to step 1806.

In step 1806, data elements are accessed from a variety of data sources. Each of the data elements is associated with criteria. The criteria is used to project expected electricity output from new renewable energy sources. The criteria include a portfolio of a plurality of parcels of land, each with i) land characteristics, ii) electricity transmission characteristics, and iii) market demand characteristics.

In one example, the criteria of land characteristics for each parcel of land in the portfolio may be any combination of electricity transmission characteristics of the parcel, and market demand characteristics of the parcel. Further, these criteria may include any combination of the size of the parcel, ownership of the parcel, tree coverage in the parcel and/or tree clearing costs, the elevation of the parcel, terrain of the parcel, buildable land area of the parcel, location of the parcel to nearby renewable projects, or a land owner's willingness to grant rights to the parcel, i.e., sentiment score boost. Other criteria for each parcel of land in the portfolio may include the plurality of criteria further includes at least one resource score that is based on the strength of the wind or solar in each of the plurality of parcels of land.

In another example, the criteria of transmission characteristics for each parcel of land in the portfolio may include the size of substation hardware costs, network upgrade costs, or grid tie-in costs. The process continues to step 1808.

In step 1808, each of the plurality of data elements is converted into a uniform data format within each of the criteria. The process continues to step 1810.

In step 1810, the process begins a loop in which a total number of simulations (M) are executed in parallel up to the total number of jobs or until a time period expires by step 1812 and step 1814.

In step 1812, by evaluating each of the plurality of parcels of land in the portfolio, including the land characteristics, the electricity transmission characteristics, and the market demand associated with the parcels of land in the portfolio. Next, in step 1814, a clustering algorithm is executed to produce results, wherein the results include a subset of the plurality of parcels of land in the portfolio. The process continues to step 1816. If the number of simulations is complete or the time period expires, the process continues to step 1818. Otherwise, the process returns to step 1810.

In step 1818, the results are ranked from the total number of simulations (M) that meet the electricity requirement combined with a highest combined score of a cumulative size of the subset of the plurality of parcels of land in the portfolio, the electricity transmission characteristics, and the market demand. The process continues to step 1820.

In step 1820, the results may be displayed in various formats with various color overlays on maps illustrating the combination of the parcels of land with the highest ranking for development based on the criteria. The process ends in step 1822.

General Computer for Implementing Algorithm

The present invention can be implemented on a standalone computer system, a server, a web-server, a cloud computing system or a hybrid cloud system, or other on-demand availability of computer system resources, especially data storage and computing power, without direct active management by the user.

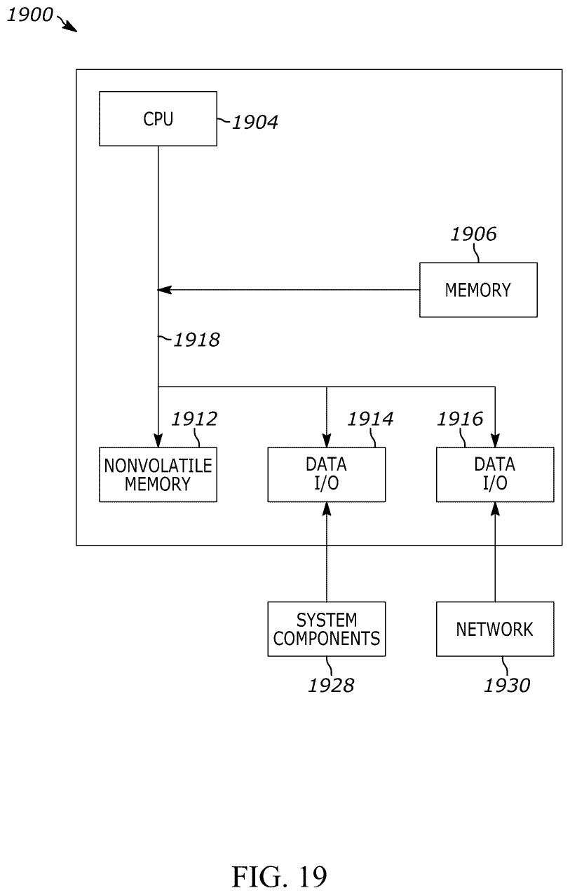

FIG. 19 illustrates a block diagram illustrating a processing system 1900 for carrying out a portion of the present invention, according to an example. The processor system 1900 is an example of a processing subsystem that is able to perform any of the above-described processing operations, other operations, or combinations of these, such as the flow diagram of FIG. 19.

The processor 1900 in this example includes a hardware processor or CPU 1904 that is communicatively connected to a main memory 1906 (e.g., volatile memory), a non-volatile memory 1912 to support processing machine instruction and operations. The CPU is further communicatively coupled to a network adapter hardware 1916 to support input and output communications with external computing systems such as through the illustrated network 1930.

The processor 1900 further includes a data input/output (I/O) processor 1914 that is able to be adapted to communicate with any type of equipment, such as the illustrated system components 1928. The data input/output (I/O) processor, in various examples, is able to be configured to support any type of data communications connections, including present-day analog and/or digital techniques or via a future communications mechanism. A system bus 1918 interconnects these system components.

### Information Processing System

The present subject matter can be realized in hardware, software, or a combination of hardware and software. A system can be realized in a centralized fashion in one computer system or in a distributed fashion where different elements are spread across several interconnected computer systems. Any kind of computer system—or other apparatus adapted for carrying out the methods described herein—is suitable. A typical combination of hardware and software could be a general-purpose computer system with a computer program that, when being loaded and executed, controls the computer system such that it carries out the methods described herein.

The present subject matter can also be embedded in a computer program product, which comprises all the features enabling the implementation of the methods described herein, and which—when loaded in a computer system—is able to carry out these methods. The computer program in the present context means any expression, in any language, code, or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory. CD-ROM, and other permanent storage. Additionally, a computer medium may include volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information. In general, the computer readable medium embodies a computer program product as a computer readable storage medium that embodies computer readable program code with instructions to control a machine to perform the above-described methods and realize the above-described systems.

### Non-Limiting Examples

Although specific embodiments of the subject matter have been disclosed, those having ordinary skill in the art will understand that changes are made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

1. A computer-implemented method for positioning a delineation over a combination of parcels of land on a graphical user interface (G.U.I.) of a computer system, the method comprising:
receiving, via a G.U.I. at least partially rendered on a computer screen, a user selection to automatically identify a combination of parcels of land on a map based on specific criteria, wherein the specific criteria is an electricity requirement for a new renewable energy generation facility;
performing a plurality of project projections by:
accessing a plurality of data elements, each associated with one of a plurality of criteria, and each of the plurality of criteria is used to project expected electricity output from at least one of a plurality of new renewable energy sources, and the plurality of criteria includes a portfolio of a plurality of parcels of land, and for each parcel of land in the portfolio, the plurality of criteria includes
an amount of buildable land for each of a plurality of capacities,
at least one land characteristic of the parcel, wherein the at least one land characteristic includes ownership of the parcel,
at least one electricity transmission characteristic of the parcel, and
at least one market demand characteristic of the parcel;
executing a total number of simulations (M) simultaneously in parallel, over each of the plurality of capacities and thousands of various clusters of parcels of land all with the plurality of criteria by,
evaluating each of the plurality of parcels of land in the portfolio including the at least one land characteristic, the at least one electricity transmission characteristic, and the at least one market demand associated with the parcels of land in the portfolio; and
executing a clustering algorithm to produce results, wherein the results include a subset of the plurality of parcels of land in the portfolio;
ranking the results from the total number of simulations (M) that meet an electricity requirement for a new renewable energy generation facility combined with a highest combined score of a cumulative size of the subset of the plurality of parcels of land in the portfolio, the at least one electricity transmission characteristic, and the at least one market demand, and wherein the ranking the results from the total number of simulations (M) includes applying a higher priority to minimizing a number of land owners for a new renewable solar energy sources as compared with minimizing the number of land owners for a new renewable wind energy sources; and
modifying on the computer screen a display of an image of at least one parcel of land based on automatically positioning a delineation over the combination of parcels of land on the map displayed on the G.U.I., based on the specific criteria and a highest ranking for at least one of the plurality of capacities.

2. The computer-implemented method of claim 1, wherein the executing the total number of simulations (M) are executed in parallel up to a total number of jobs or until a time period expires.

3. The computer-implemented method of claim 2, wherein the total number of simulations, the time period, or both are settable by a user.

4. The computer-implemented method of claim 1, wherein for each parcel of land in the portfolio, the at least one land characteristic includes one or more of size of the parcel, ownership of the parcel, tree coverage in the parcel, elevation of the parcel, terrain of the parcel, buildable land area of the parcel, location of the parcel to nearby renewable projects, or a land owner's determined willingness to sell rights to the parcel.

5. The computer-implemented method of claim 4, wherein for each parcel of land in the portfolio, the at least one land characteristic includes tree clearing costs of each parcel.

6. (canceled)

7. The computer-implemented method of claim 1, wherein for each parcel of land in the portfolio, the at least one land characteristic includes whether the land borders at least one of rivers, highways or both, and wherein the ranking the results from the total number of simulations (M) includes reducing the ranking for any land characteristic that borders the at least one of rivers, highways or both.

8. The computer-implemented method of claim 1, wherein for each parcel of land in the portfolio, the plurality of criteria further includes at least one resource score that is based on strength of wind or solar in each of the plurality of parcels of land.

9. The computer-implemented method of claim 1, wherein for each parcel of land in the portfolio, the at least one electricity transmission characteristic includes one or more of size of substation hardware costs, network upgrade costs, or grid tie-in costs.

10. (canceled)

11. The computer-implemented method of claim 1, wherein the electricity requirement is for new renewable solar energy sources.

12. The computer-implemented method of claim 1, wherein the electricity requirement is for a new renewable wind energy sources.

13. The computer-implemented method of claim 1, wherein the electricity requirement is for a new renewable battery energy sources are batteries.

14. The computer-implemented method of claim 11, wherein for each parcel of land in the portfolio, the at least one land characteristic includes proximity to fiber and transmission substations.

15. A system for positioning a delineation over a combination of parcels of land on a graphical user interface, the system comprising:
a computer memory capable of storing machine instructions; and
a hardware processor in communication with the computer memory, the hardware processor configured to access the computer memory to execute the machine instructions for performing a plurality of project projections by:
receiving, via a G.U.I. at least partially rendered on a computer screen, a user selection to automatically identify a combination of parcels of land on a map based on specific criteria, wherein the specific criteria is an electricity requirement for a new renewable energy generation facility;
accessing a plurality of data elements, each associated with one of a plurality of criteria, and each of the plurality of criteria is used to project expected electricity output from at least one of a plurality of new renewable energy sources, and the plurality of criteria includes a portfolio of a plurality of parcels of land, and for each parcel of land in the portfolio, the plurality of criteria includes,
an amount of buildable land for each of a plurality of capacities,
at least one land characteristic of the parcel, parcel,
at least one electricity transmission characteristic of the parcel, and
at least one market demand characteristic of the parcel;
executing a total number of simulations (M) simultaneously in parallel, over each of the plurality of capacities and thousands of various clusters of parcels of land all with the plurality of criteria by,
evaluating each of the plurality of parcels of land in the portfolio including the at least one land characteristic, the at least one electricity transmission characteristic, and the at least one market demand associated with the parcels of land in the portfolio; and
executing a clustering algorithm to produce results, wherein the results include a subset of the plurality of parcels of land in the portfolio;
ranking the results from the total number of simulations (M) that meet an electricity requirement for a new renewable energy generation facility combined with a highest combined score of a cumulative size of the subset of the plurality of parcels of land in the portfolio, the at least one electricity transmission characteristic, and the at least one market demand and wherein the ranking the results from the total number of simulations (M) includes applying a higher priority to minimizing a number of land owners for a new renewable solar energy sources as compared with minimizing the number of land owners for a new renewable wind energy sources; and
modifying on the computer screen a display of an image of at least one parcel of land based on automatically positioning a delineation over the combination of parcels of land on the map displayed on the G.U.I., based on the specific criteria and a highest ranking for at least one of the plurality of capacities.

16. The system of claim 15, wherein the executing the total number of simulations (M) are executed in parallel up to a total number of jobs or until a time period expires.

17. The system of claim 16, wherein the total number of simulations, the time period, or both are settable by a user.

18. The system of claim 15, wherein for each parcel of land in the portfolio, the at least one land characteristic includes one or more of size of the parcel, ownership of the parcel, tree coverage in the parcel, elevation of the parcel, terrain of the parcel, buildable land area of the parcel, location of the parcel to nearby renewable projects, or a land owner's determined willingness to sell rights to the parcel.

19. The system of claim 18, wherein for each parcel of land in the portfolio, the at least one land characteristic includes tree clearing costs of each parcel.

20. (canceled)
